(19) United States
(12) Patent Application Publication
(10) Pub. No.: US 2002/0053330 A1
(43) Pub. Date: May 9, 2002

(54) Gasoline motor powered working machine

(76) Inventors: Ove Donnerdal, Savedalen (SE); Magnus Soderqvist, Molndal (SE)

Correspondence Address: Michael D. Bednarek, SHAWPITTMAN, 2300 N Street, N.W., Washington, DC, 20037-1128, US

(21) Appl. No.: 09/817,062

(22) Filed: Mar. 27, 2001

(30) Foreign Application Priority Data
Apr. 5, 2000 (SE) 0001226-0

(51) Int. Cl. F02D 11/02

(52) U.S. Cl. 123/179.18; 123/198 DC

(57) ABSTRACT

A gasoline motor powered, hand-operated working machine has a stop device with a stop control designed as a toggle switch. The stop control (11) including a grip member (13) is an integrated part of a rocker (12), which is turnable about an axis of rotation and is substantially recessed in a wall of the working machine in the drive position of the machine, when the stop device is mounted on the machine, while it in a fixed stop position is substantially turned out from said wall.

### TECHNICAL FIELD

The invention relates to a gasoline motor powered, hand-operated working machine having a rear operating handle with motor control, including a starter throttle control on one side of the operating handle, which starter throttle control must be pressed into the operating handle before start, and wherein the working machine includes a stop control having two end positions; a drive position for start of the engine and for motion of the engine and a fixed stop position.

### BACKGROUND OF THE INVENTION

According to current safety regulations, the stop control of gasoline motor powered, hand-operated working machines must have a fixed stop position, which shall be possible to be adopted therein that the operator moves the stop control from the drive position to the fixed stop position through a single, uninterrupted movement. The reason for this regulation is that the machine safely shall be able to be stopped in an emergency situation. But also in case of occasional stops, e.g. for periods of rest, refuelling etc., the stop control of existing machines need to be moved to the fixed end stop in order to stop the motor. Before the machine can be restarted, the stop control must be brought back to the drive position. It frequently happens that the operator forgets to do that and repeatedly pulls the starter rope until he becomes aware of his mistake, and this is particularly true when existing stop controls have the shape of a knob or slide which does not provide any readily visible signals. Meanwhile the engine often has become “wet”, which makes the start difficult.

### BRIEF DISCLOSURE OF THE INVENTION

It is the purpose of the invention to address the above mentioned problem.

In order to solve said problem, the invention, according to a first aspect of the invention, is characterised therein that the stop device is designed as a toggle switch, that the stop control including a grip member is an integrated part of a rocker having a first lever, which is turnable about an axis of rotation and is substantially recessed in a wall of the working machine in the drive position of the machine, when the stop device is mounted on the machine, and that it in the fixed stop position is substantially turned out from said wall.

Preferably, the rocker is turnable about said axis of rotation, which is vertical in the normal operating state of the machine in a breaker housing, provided to be mounted recessed in a wall of the working machine.

According to another aspect of the invention, which relates to a preferred embodiment, the working machine is of the type which includes a rear operating handle with a starter throttle control on one side of the operating handle, which starter throttle control must be pressed into the operating handle before start. The invention according to this aspect of the invention is characterised therein that the stop device is designed as a toggle switch in a wall at the side of the starter throttle control, and that a first, outer lever of a rocker of the toggle switch, in the fixed stop position, is substantially turned out from the wall of the machine at the side of the operating handle in a direction towards the starter throttle control to a position outside of the starter throttle control, such that the starter throttle control is made difficult to access by the machine operator, while said lever in the drive position is turned away from the starter throttle control and substantially into said wall, such that the starter throttle control is made easy to access.

Further aspects and characteristic features of the invention will be apparent from the appending patent claims and from the following description of the invention.

### BRIEF DESCRIPTION OF DRAWINGS

In the following detailed description of the invention, reference will be made to the accompanying drawings, in which

FIG. 1 shows a conceivable application of the invention in a perspective view of a schematically shown portion of the machine comprising a stop control in its drive position; and

FIG. 2 shows the same machine with the stop control in a fixed stop position.

### DETAILED DESCRIPTION OF THE INVENTION

With reference to the drawings, there is schematically shown the rear wall 1 of a motor housing 2 of a gasoline motor powered, portable and hand-operated working machine, more particularly a cutter. An operating handle, intended to be gripped by the operator's right hand, is designated 3. In connection with the operating handle there is in a conventional way a throttle control 4 under the operating handle, an idling catch 5 on the upper side of the operating handle, and a starter throttle control 6 on the left hand side of the operating handle 3. To make it possible to start the motor, the starter throttle control 6 in a manner known per se first must be pressed into the operating handle 3 by the operator. This is normally made by the operator's right hand thumb.

On the rear side 1 of the motor housing, to the left of the operating handle 3 and at level with the starter throttle control 6 there is provided a stop device 10 for the engine. The stop device 10 comprises a stop control 11, which is designed with a rocker 12 with a finger grip 13. The stop control 11 is operated by turning the rocker 12 by means of the finger grip 13 about a vertical axis of rotation 15.

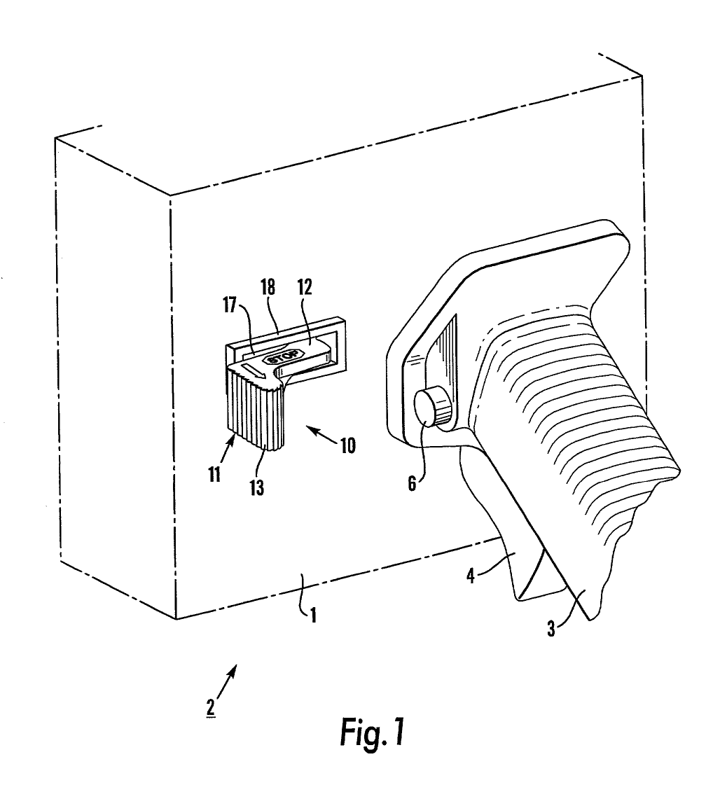

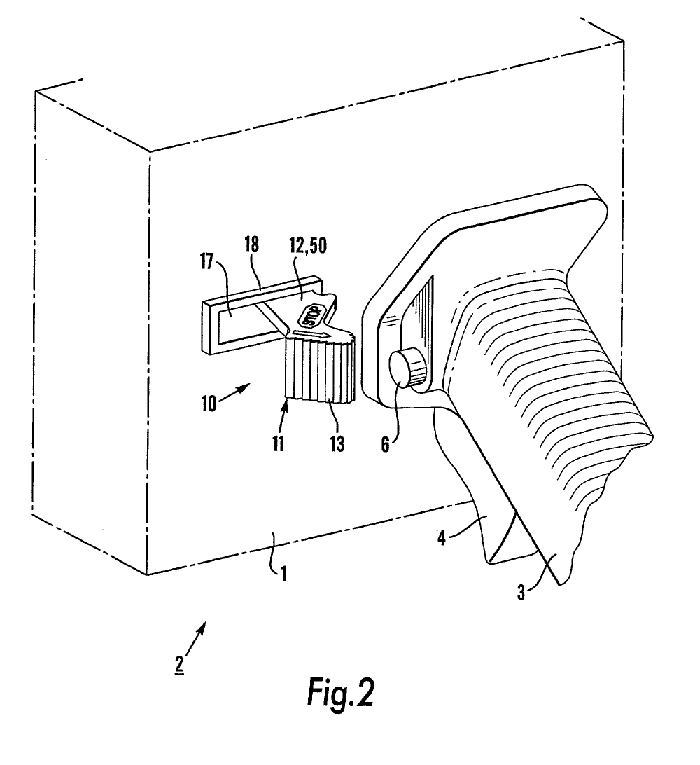

When the rocker 12 with finger grip 13 is in the drive position of the stop control 11, the rocker 12 is substantially turned in into and is protected in a breaker housing 17 inside a frame 18 on the rear wall 1 of the motor housing 2, so that so that only the finger grip 13 projects to any essential degree from the motor housing wall. The starter throttle control 6 in this position is easy to access by the operator and allows start of the engine, FIG. 1. When the stopper control 11 with the rocker 12 and the finger grip 13 is in the fixed stop position, FIG. 2, the rocker with an outer lever 50, which has the finger grip 13 in the outer end thereof, on the other hand is turned out from the motor housing wall 1, so that the finger grip 13 prevents the operator to access the starter throttle control 6 with his thumb. At least this requires so much trouble that the operator becomes aware of the fact that the stop device is in its fixed stop position. The operator therefore is more or less forced to move the stop control 11 from its fixed stop position, FIG. 2, to the drive position, FIG. 1, before he can press in the starter throttle control 6 and start the engine. At that type of machines where the motor stop device is located, or can be located, at the rear side of the motor housing adjacent to the starter throttle control 6, the described arrangement, according to one aspect of the invention, thus is a very efficient means for preventing the operator to start the engine with the stop device in the stop position, but also if the stop device 10 has another location than adjacent to the starter throttle control 6, the projecting position of the rocker 12, and particularly the position of the projecting finger grip 13, is a readily visible indication that the stop device is in its fixed stop position, which can prevent many attempts to start the engine in that position. Moreover, the signal action of the finger grip 13 in the turned out position can be enhanced, if it has a different colour than the wall 1.

According to the embodiment the stop device 10 thus is designed to prevent attempts to start in the fixed stop position independent of mounting location therein that the rocker with the finger grip 13 projects pronouncedly in the stop position, and in the specifically shown location of mounting also therein that the rocker makes the starter throttle control difficult to access.

1. A gasoline motor powered, hand-operated working machine having a stop device with a stop control, characterised therein that the stop device (10) is designed as a toggle switch, that the stop control (11) including a grip member (13) is an integrated part of a rocker (12), which is turnable about an axis of rotation and is substantially recessed in a wall of the working machine in the drive position of the machine, when the stop device is mounted on the machine, and that it in the fixed stop position is substantially turned out from said wall.

2. A machine according to claim 1, characterised therein that the rocker is turnable in a breaker housing (17), which is recessed in said wall.

3. A machine according to claim 1 or claim 2 including a rear operating handle (3) with a starter throttle control (6) on one side of the operating handle, which starter throttle control must be pressed in into the operating handle before start, characterised therein that the stop device is designed as a toggle switch in a wall at the side of the starter throttle control, and that a lever (50) of the rocker in the fixed stop position is substantially turned out from the wall of the machine at the side of the operating handle in a direction towards the starter throttle control, such that the starter throttle control is made difficult to access by the machine operator, while said lever in the drive position is turned away from the starter throttle control and substantially into said wall, such that the starter throttle control is made easy to access.
